(19) United States
(12) Patent Application Publication
(10) Pub. No.: US 2010/0270160 A1
(43) Pub. Date: Oct. 28, 2010

(54) Portable Low Power Charged Particle Analysis Device

(75) Inventors: Faisal Aezazuddin Shaikh, Milwaukee, WI (US); Faiz Aezazuddin Shaikh, Kansas City, MO (US)

Correspondence Address: NAF Technologies LLC, 7502 Loma Vista DR, Kansas City, MO, 64138, US

(73) Assignee: NAF TECHNOLOGIES LLC, KANSAS CITY, MO (US)

(21) Appl. No.: 12/764,502

(22) Filed: Apr. 21, 2010

Related U.S. Application Data
(60) Provisional application No. 61/171,547, filed on Apr. 22, 2009.

(51) Int. Cl. B01D 57/02; G01N 27/26

(52) U.S. Cl. 204/601

(57) ABSTRACT

The present invention is a portable low power system for charged particle analysis using electro kinetic flow in a Microfluidic channel, which may be interfaced with a computing device. The system consists of three parts: A required hardware device, an optional software client application and an optional software server application. The hardware based device may control the flow of ions through a Microfluidic channel based on specific analysis protocols and analyzes the sample to identify the ions; the optional software based client and server applications may support the process by performing at least one of following functions: hosting the analysis, hosting newly detected and old analyte signature data, and analyzing the detected signatures.

The hardware device may contain at least one of the three optionally connected sections controlling the flow of charged ions through the Microfluidic channel: One for ion extraction; this may be used if the charged particle such as a nucleic acid needs to be extracted or separated from its enclosing cell. The second section is for ionic concentration which involves keeping at least one electrode charged sufficiently long enough for the ions to accumulate at its surface electrokinetically. The third section consists of introducing the ion such as a nucleic acid in an electric field and identifying it based on its displacement in the channel in a specific time period. Each section may be absent from the system or bypassed either systematically or manually by not introducing the ion in the bypassed section.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of Microfluidics. More particularly, the present invention is a lab-on-chip system involving electro kinetics to extract, concentrate, separate and analyze charged particles in a Microfluidic channel containing a buffer solution

Microfluidic DNA analysis technology has grown to a stage where an integrated device can be built that can handle multiple analyte analysis steps. The invention claimed is for such a handheld device with an electronic interface that can connect the lab-on-chip with a computer and compare with existing ionic profiles either on a local or online database. This would allow rapid, portable, reliable, inexpensive, and less labor-intensive identification of ionic vectors with lesser chances of a sample being compromised.

The Inventors have refined the nucleic acid analysis technology employing microfabricated electrode arrays incorporated in the microchannel to purify, concentrate, focus, inject, and analyze the nucleic sample with gel-electrophoresis (Shaikh et al., Proc. Natl. Acad. Sci. (U.S.A.) 103, 4825-4830 (2006) the entirety of which is herein incorporated by reference). Nucleic acid extraction will be carried out with immobilized solid phases inside the microchannel (Manz et al., J. Chroma. 593, 253-258 (1992) the entirety of which is herein incorporated by reference), followed by infrared mediated thermocycling for the PCR reaction (Roper et al. Analytical Chemistry 79(4), 1294-300 (2007) the entirety of which is herein incorporated by reference) have been demonstrated to be effective for the purpose of this invention.

### BRIEF SUMMARY OF THE INVENTION

The present invention is a portable electronic lab-on-a-chip device for analyzing amino acid polymers supported by software applications. The base device consists of electrode arrays and driver circuitry, which hosts the disposable plug and play microchannel arrangement. Apart from the onboard ASIC that controls the analysis process, the system has a computer based client that can talk with the device and an internet based server application to update the system software, analysis rules, and signature data. These sections would provide a fully integrated portable nucleic acid analysis device with rapid processing times.

### BRIEF DESCRIPTION OF THE SEVERAL VIEWS OF THE DRAWING

FIG. 1 is an exploded view of the Microfluidic channel assembly of an analysis device of the present invention;

FIG. 2 is a perspective view of a Microfluidic channel portion of the analysis device of FIG. 1;

FIG. 3 is a top view of a detachable Microfluidic channel assembly that attaches to the analysis device of FIG. 1, containing the nucleic acid extraction, concentration and signature detection sections;

FIG. 4 is a top view of an analysis device of the present invention, with the Microfluidic channel assembly attached to the base device;

### DETAILED DESCRIPTION OF THE INVENTION

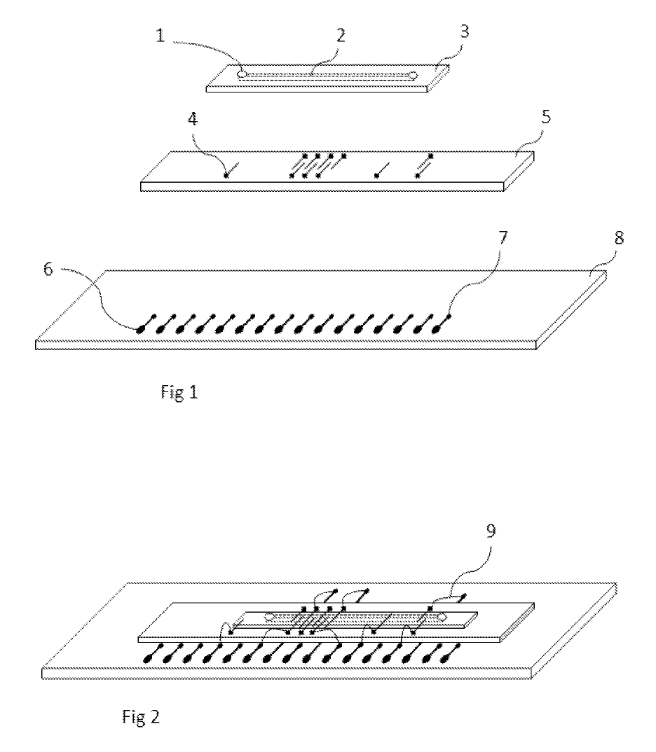

Referring now to the invention in more detail, in FIG. 1, there is shown an exploded view of an implementation of a Microfluidic channel assembly of the present invention. In more detail, the disposable assembly consisting of parts 3 and 5 latch onto the base 8.

In further detail, still referring to the invention of FIG. 1, the part 3 has an access hole for sample introduction 1 and a microchannel 2 etched underneath.

In further detail, still referring to the invention of FIG. 1, the part 5 has microfabricated electrodes 4 that are introduced into the microchannel 2. In more detail, parts 3 and 5 combined form the disposable and detachable section of the device

In further detail, still referring to the invention of FIG. 1, the part 8 contains the electrodes that attach or latch onto the electrodes of part 5.

The construction details of the invention as shown in FIG. 1 are that parts 3 and 5 maybe made of glass, plastic, any transparent non-conductive material or a combination thereof. In more detail, the electrodes, may be microfabricated or attached externally and made of any conductive and preferably non-corrosive material like stainless steel, copper, bronze and the like. In further detail, the part 8 may be made of polyurethane plastic or of any other sufficiently rigid and strong material such as high-strength fiberglass, metal, and the like, or a combination thereof.

Referring now to the invention in more detail, in FIG. 2, there is shown an implementation of a perspective view of a Microfluidic channel portion of the analysis device. In further detail, the wire bond 9 between parts 5 and 8 may be a detachable electric contact.

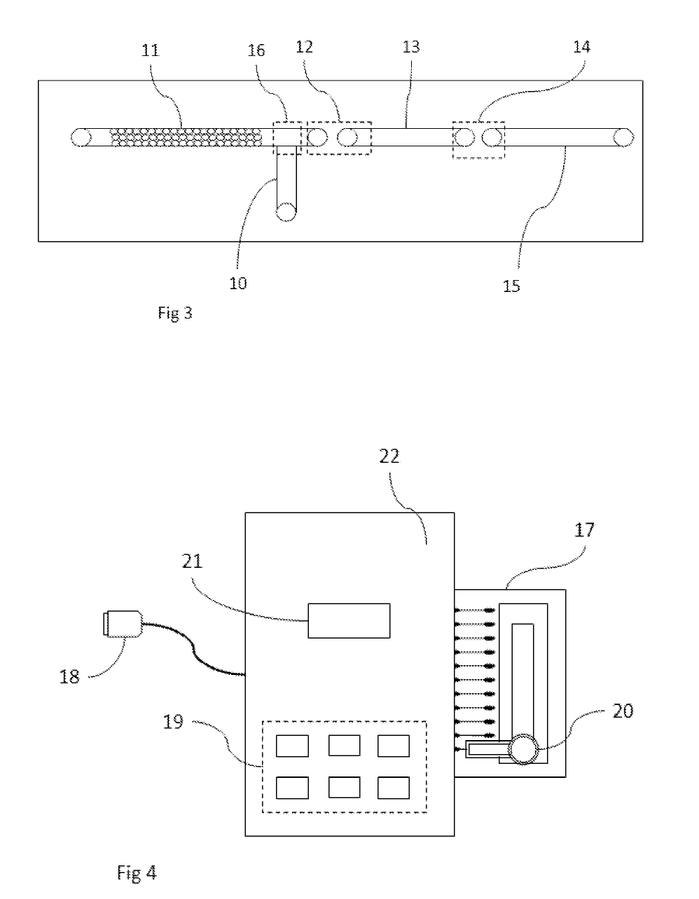

Referring now to FIG. 3, there is shown a top view of a detachable Microfluidic channel assembly that attaches to the analysis device of FIG. 1, containing the nucleic acid extraction 11, concentration 12 and signature detection 14 sections. Further the individual sections of the microchannel assembly are detachable and may optionally be disposable. The Microfluidic channel assemblies each have at least one entry and one exit section to introduce the buffer solution and the analysis sample.

In more detail, referring to the invention of FIG. 3, section 11 of the Microfluidic channel assembly contains the nucleic acid extraction section. This may be constructed using immobilized solid phases inside the microchannel (Manz et al., J. Chroma. 593, 253-258 (1992), the entirety of which is herein incorporated by reference).

In more detail, referring to the invention of FIG. 3, section 12 of the Microfluidic channel assembly shown is used for nucleic acid concentration. This concentration section relies on using electric fields applied between adjacent electrodes to attract and thereby concentrate nucleic acid molecules. In further detail, this assembly is uniformly hollow and rests on the electrode array of the device as shown in FIG. 1. Further this assembly can join with the assembly referred in section 11 and/or be joined to the assembly referred in section 13 or be used in its own right

In more detail, referring to the invention of FIG. 3, section 10 of the Microfluidic channel assembly shown is an optional electrically controlled gate for introducing any post extraction reactant. Further, still referring to the section 10 of the invention of FIG. 3, it may be used to introduce enzymes to break nucleic acids into short tandem repeats.

In continuance, still referring to the inventions of FIG. 3 section 13 of the Microfluidic channel assembly is used for signature detection. The signature of the sample refers to the displacement of the sample under given voltage, amperage and time constants. In more detail, referring to the signature detection section 13, the said displacement is proportional to the charge and size of the sample's molecules.

In further detail, still referring to the inventions of FIG. 3 the Microfluidic channel assembly sections may be arranged in different fashion, either parallel, in series or at an angle to each other.

In further continuance, still referring to the inventions of FIG. 1 through FIG. 3 the Microfluidic channel assembly sections may not be detachable and either fused or a part of the invention referred to in FIG. 4.

The construction details of the invention as shown in FIG. 3 the Microfluidic channel assembly shown is used for only the nucleic acid concentration section. In more detail, this assembly maybe uniformly or non-uniformly hollow and rests on the electrode array of the device as shown in FIG. 1.

In further detail, now referring to the invention of FIG. 4, there is shown an assembled device. The base device 16 has a USB interface 18 with the computing device, and the electronic section 15 that holds the system software. The system software in the ASIC 15 controls the potential applied to the electrodes, and controls the CCD imager 20. Part 18 can optionally be an Ethernet, RS 232, Firewire port or the like thereof. The base device can be powered through the connected interface, an external power supply, or via an on-board power supply

In further detail, now referring to the invention of FIG. 4, part 19 depicts optional buttons to control, display the status of the device and/or execute preconfigured runs.

In continuance, the electronic section 15 can be a customized ASIC or any generic embedded system either microcontroller or FPGA based and the like.

The construction details of the invention as shown in FIG. 4 are that parts 16, 17, 18 and 19 may be made of polyurethane plastic or of any other sufficiently rigid and strong material such as high-strength fiberglass, metal, and the like, or a combination thereof. Further, the various components of the device can be made of different materials.

The advantages of the present invention include, without limitation that it is portable and exceedingly easy to transport. It is easy to use the invention indoors or outdoors. The use of these devices would radically shorten among other processes the DNA and protein analysis times.

In broad embodiment, the present invention is an electronically controlled portable low power lab-on-a-chip ion analysis device.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

1. A portable system for charged particle analysis, using electro kinetics in a Microfluidic channel which may be interfaced with a computing device. The system consists of three parts: a. A required hardware device, b. an optional software based client application and c. an optional software based server application.

2. The device of claim 1, wherein said device controls the flow of ions through an optionally portable detachable and disposable Microfluidic channel based on specific analysis rules and analyzes the flow to detect the ion signature

3. The software based client application of claim 1, wherein said application may support the process by performing at least one of following functions: a. hosting the analysis protocols, b. hosting newly detected and old analyte signature data, c. hosting and serving the analysis rules, and d. analyzing detected analyte signatures

4. The software based server application of claim 1, wherein said application may support the process by performing at least one of following functions: a. hosting and serving the analyses rules, b. hosting and serving newly detected and old ion signature data, c. hosting and serving the analyses logs, and d. analyzing detected ion signatures.

5. The device of claim 1, wherein said device consists of a base electronic driver circuitry that electrically controls the flow of charged analytes through a buffer solution in the Microfluidic channel that may contain at least one of the three optionally connected sections: a. One for charged analyte extraction; b. The second section is for concentrating the analyte, c. The third for ion breakdown and d. The third section for ionic detection

6. The device of claim 1, wherein said device interfaces electronically with the software based client application of claim 1, and optionally with the software based server application of claim 1, via any of the existing electronic data transfer techniques i.e. USB or the internet.

7. The ion extraction section of claim 5, wherein said section may be used if the charged chemical species such as a nucleic acid needs to be extracted or separated from its enclosing cell.

8. The ion concentration section of claim 5, wherein said section involves keeping at least one electrode around the Microfluidic channel charged sufficiently long enough for the ions to accumulate around them

9. The ion breakdown section of claim 5, wherein said section involves introducing a gated reactant into the channel to break it down into smaller molecules, like short tandem repeats for nucleic acids.

10. The ion analysis section of claim 5, wherein said section introduces the ion such as a nucleic acid in an electric field of specified strength and identifies it based on its displacement and/or velocity profile in the Microfluidic channel in a specific time period

11. The measurement of displacement or velocity of claim 8, wherein said measurement is done by, optionally magnifying, and imaging the Microfluidic channel

12. The three optional sections of claim 5, wherein said sections may be absent from the system or bypassed either systematically or manually by not introducing the ion in the bypassed section

13. The analysis rules of claims 3 and 4, wherein said rules dictate the type actions to be performed by the device, viz. the sequence, amount and duration for which the charge between specific electrodes is to be applied, and the imaging control information

14. The analysis rules of claims 3 and 4, wherein said rules can indicate a new ion signature detection process

15. The ion signature data of claims 3 and 4, wherein said data is the digital representation of the displacement and velocity profiles of individual ions qualified by distance, time and potential differences

16. The ion signature data of claims 3 and 4, wherein said data is unique to a charge and size of the ion, and can be used to uniquely identify the ion

17. The ion signature data of claims 3 and 4, wherein said data can be used to match with detected signature from the hardware device of claim 2, and provide a probabilistic match of the sample

18. The ion signature data of claims 3 and 4, wherein said data is unique to a specific nucleic acid or short tandem repeat thereof

19. The software based client application of claim 1, wherein said application may run on a mobile or portable computing platform

20. The software based server application of claim 1, wherein said application may run on a mobile or portable computing platform
